(19) United States
(12) Patent Application Publication
(10) Pub. No.: US 2026/0264002 A1
(43) Pub. Date: Sep. 10, 2026

(54) GAS PURIFICATION METHOD

(71) Applicant: Shenyang Starlight New Materials Co., Ltd., ShenyangCity (CN)

(72) Inventors: Yun REN, ShenyangCity (CN); Jianliang HAO, ShenyangCity (CN); Xia REN, ShenyangCity (CN); Yuduo JIN, ShenyangCity (CN); Qiuyue ZHANG, ShenyangCity (CN); Siyu ZHANG, ShenyangCity (CN)

(73) Assignee: Shenyang Starlight New Materials Co., Ltd., ShenyangCity (CN)

(21) Appl. No.: 19/354,553

(22) Filed: Oct. 9, 2025

(30) Foreign Application Priority Data
Mar. 6, 2025 (CN) 202510259852.0

(51) Int. Cl. B01D 53/22; B01D 63/06; B01D 67/00; B01D 69/02; B01D 71/02

(52) U.S. Cl. CPC B01D 53/228; B01D 63/061; B01D 67/00411; B01D 67/0051; B01D 69/02; B01D 71/0215; B01D 2053/223; B01D 2256/10; B01D 2323/081; B01D 2323/12; B01D 2325/24; B01D 2325/30

(57) ABSTRACT

Provided is a gas purification method, which belongs to the technical field of purification. The gas purification method provided in the present disclosure includes: subjecting a to-be-treated gas to purification using a recrystallized silicon carbide (R-SiC) gas filtration membrane to obtain a purified gas, where the R-SiC gas filtration membrane is prepared by a process including: mixing SiC, cellulose, dextran, vegetable oil, glycerol and water, and performing kneading to obtain a kneaded material; subjecting the kneaded material to extrusion molding, drying and degumming in sequence to obtain a degummed green body; and subjecting the degummed green body to sintering-coating treatment to obtain the R-SiC gas filtration membrane. In the present disclosure, the to-be-treated gas is purified by using the R-SiC gas filtration membrane. The R-SiC gas filtration membrane is resistant to acids, alkalis and high temperatures to facilitate direct purification on the corrosive high-temperature gas.

### TECHNICAL FIELD

The present disclosure relates to the technical field of purification, and in particular to a gas purification method.

### BACKGROUND

With the industrial development, gases generated in many production processes contain certain toxic and harmful components, and need to be purified for use in follow-up processes or for discharge. Filtration membranes for purifying the gases are operated conveniently and have been widely used.

At present, the filtration membranes for purifying the gases are mainly organic polymer gas filtration membranes, such as polytetrafluoroethylene (PTFE) membranes or polyvinylidene fluoride (PVDF) membranes. The organic polymer gas filtration membranes exhibit desirable acid and alkali resistance, but are not resistant to high temperatures. Typically, the gases need to be cooled rapidly before treated, causing an energy waste.

### SUMMARY

An object of the present disclosure is to provide a gas purification method. In the present disclosure, the to-be-treated gas is purified using the recrystallized silicon carbide (R-SiC) gas filtration membrane. The R-SiC gas filtration membrane is resistant to acids, alkalis and high temperatures to facilitate direct purification on the corrosive high-temperature gas.

To achieve the above object of the present disclosure, the present disclosure provides the following technical solutions:

The present disclosure provides a gas purification method, including:
subjecting a to-be-treated gas to purification using an R-SiC gas filtration membrane to obtain a purified gas, where
the R-SiC gas filtration membrane is prepared by a process including:
mixing SiC, cellulose, dextran, vegetable oil, glycerol and water, and performing kneading to obtain a kneaded material;
subjecting the kneaded material to extrusion molding, drying and degumming in sequence to obtain a degummed green body; and
subjecting the degummed green body to sintering-coating treatment on to obtain the R-SiC gas filtration membrane.

In some embodiments, the R-SiC gas filtration membrane is selected from the group consisting of a single-channel tubular membrane and a multi-channel tubular membrane; the single-channel tubular membrane has an inner diameter of 15-25 mm, an outer diameter of 30-40 mm, and a length of 1,000-1,500 mm; and each channel in the multi-channel tubular membrane has an inner diameter of 2-25 mm, and the multi-channel tubular membrane has a length of 1,000-1,500 mm.

In some embodiments, the to-be-treated gas has a pH value of 0-14, a temperature ranging from room temperature to 800° C., and an impurity content less than or equal to 5% by volume.

In some embodiments, the to-be-treated gas includes nitrogen and ammonia; and the to-be-treated gas has the pH value of 11.5-12.5, the temperature of 50-60′C, and the impurity content of 1-2.5% by volume.

In some embodiments, the to-be-treated gas includes hydrogen chloride; and the to-be-treated gas has the pH value of 3.5-4.5, the temperature of 300-350° C., and the impurity content of 1-5% by volume.

In some embodiments, the purification is performed under a condition that a flow velocity of the to-be-treated gas less than or equal to 30 m/s, a pressure less than or equal to 1 kPa, an environmental temperature less than or equal to 50° C., and a relative humidity less than or equal to 45%.

In some embodiments, a mass ratio of the SiC to the cellulose to the dextran to the vegetable oil to the glycerol to the water is 70:8-10:3-5:5-7:1-3:8-10.

In some embodiments, the kneading is performed at a temperature of 15-35° C. for a duration of 6-10 h, with a rotational speed of 15-45 rpm (revolutions per minute); and the degumming is performed at a temperature of 115-125° C. for a duration of 2-4 h.

In some embodiments, the sintering-coating treatment comprises sequentially performing sintering and coating; and the sintering-coating treatment is performed 3-4 times.

In some embodiments, the sintering each time is independently performed at a temperature of 2,400-2,500° C. for a duration of 3-5 h; a coating agent used for the coating each time includes SiC, cellulose, dextran, vegetable oil, glycerol and water; a mass ratio of the SiC to the cellulose to the dextran to the vegetable oil to the glycerol to the water in the coating agent is 70:(8-10):(3-5):(5-7):(1-3):(8-10); and the coating each time is independently performed at a pressure of 0.0005-0.0015 MPa.

The present disclosure provides a gas purification method, including: subjecting a to-be-treated gas to purification using an R-SiC gas filtration membrane to obtain a purified gas; where the R-SiC gas filtration membrane is prepared by a process including: mixing SiC, cellulose, dextran, vegetable oil, glycerol and water, and performing kneading to obtain a kneaded material; subjecting the kneaded material to extrusion molding, drying and degumming in sequence to obtain a degummed green body; and subjecting the degummed green body to sintering-coating treatment to obtain the R-SiC gas filtration membrane. In the present disclosure, the to-be-treated gas is purified using the R-SiC gas filtration membrane. The R-SiC gas filtration membrane is resistant to acids, alkalis and high temperatures to facilitate direct purification on the corrosive high-temperature gas.

Further, the organic polymer gas filtration membrane has a high damage rate and a short service life, is prone to secondary pollution, and results in the purified gas having an unstable quality. The R-SiC gas filtration membrane in the present disclosure exhibits a long service life and no secondary pollution, and results in the purified gas having a stable quality.

### BRIEF DESCRIPTION OF THE DRAWINGS

FIG. 1 illustrates a flowchart of the R-SiC gas filtration membrane according to an embodiment of the present disclosure;

FIG. 2 illustrates a physical image of the R-SiC gas filtration membrane used in Use Example 1; and

FIG. 3 illustrates a physical image of the R-SiC gas filtration membrane used in Use Example 2.

### DETAILED DESCRIPTION OF THE EMBODIMENTS

The present disclosure provides a gas purification method, including:
subjecting a to-be-treated gas to purification using an R-SiC gas filtration membrane to obtain a purified gas,
where the R-SiC gas filtration membrane is prepared by a process including:
mixing SiC, cellulose, dextran, vegetable oil, glycerol and water, and performing kneading to obtain a kneaded material;
subjecting the kneaded material to extrusion molding, drying and degumming in sequence to obtain a degummed green body; and
subjecting the degummed green body to sintering-coating treatment to obtain the R-SiC gas filtration membrane.

In the present disclosure, the gas is purified using the R-SiC gas filtration membrane. The R-SiC gas filtration membrane is resistant to acids, alkalis and high temperatures to facilitate direct purification on the corrosive high-temperature gas, and has excellent purification effect. The R-SiC gas filtration membrane used in the present disclosure is first described below in detail.

As an embodiment of the present disclosure, the R-SiC gas filtration membrane is a single-channel tubular membrane or a multi-channel tubular membrane. As an embodiment of the present disclosure, the single-channel tubular membrane has an inner diameter of 15-25 mm, specifically 21 mm, an outer diameter of 30-40 mm, specifically 35 mm, and a length of 1,000-1,500 mm, specifically 1,200 mm. The number of channels in the multi-channel tubular membrane may be customized according to customer requirements. For example, the multi-channel tubular membrane may have 19 channels, and each channel may have an inner diameter of 2-25 mm, specifically 2 mm, 4 mm, 21 mm or 25 mm. The multi-channel tubular membrane may have a length of 1,000-1,500 mm, specifically 1,200 mm. The specific size of the R-SiC gas filtration membrane may be customized according to an actual need.

As an embodiment of the present disclosure, the R-SiC gas filtration membrane is prepared as follows:
mixing SiC, cellulose, dextran, vegetable oil, glycerol and water, and performing kneading to obtain a kneaded material;
subjecting the kneaded material to extrusion molding, drying and degumming in sequence to obtain a degummed green body; and
subjecting the degummed green body to sintering-coating treatment to obtain the R-SiC gas filtration membrane.

In the present disclosure, unless otherwise specified, the raw materials used are all commercially-available commodities well known to those skilled in the art or prepared by methods well known to those skilled in the art.

In the present disclosure, the SiC, the cellulose, the dextran, the vegetable oil, the glycerol and the water are mixed, and the kneading is performed to obtain the kneaded material. As an embodiment of the present disclosure, a mass ratio of the SiC to the cellulose to the dextran to the vegetable oil to the glycerol to the water is 70:(8-10):(3-5):(5-7):(1-3):(8-10), specifically 70:9:6:2:9. In the embodiment of the present disclosure, the SiC has a purity of 99.8 wt %, and a particle size of 0.7-1.2 μm; the SiC with a particle size ≥1 μm accounts for 50% or more of a total weight of the SiC; the glycerol is food-grade glycerol with a purity of 98%; the dextran is dextran xt300; and the water is purified water. In the present disclosure, the SiC is used as a matrix material to form a main body of the gas filtration membrane. The SiC with the above proportion and particle size facilitates the improvements on a strength of the gas filtration membrane and a throughput of the membrane body (namely a membrane flux). In the present disclosure, the glycerol and the dextran are used as a binder. With the combination of the glycerol and the dextran in the above proportion, gaps between SiC particles can be filled, and the SiC particles can be bound together, ensuring smooth operation of extrusion and follow-up processes to obtain a gas filtration membrane with excellent performance. In the present disclosure, the cellulose can provide a binding force, ensuring that the membrane body cannot be loosened or cracked. In the present disclosure, the vegetable oil and the water are used as a dispersant, such that each raw material can be dispersed and mixed uniformly to obtain the gas filtration membrane with excellent uniformity.

As an embodiment of the present disclosure, mixing the SiC, the cellulose, the dextran, the vegetable oil, the glycerol and the water is performed by mixing the SiC, the cellulose and the dextran, and then mixing a resulting mixture with the water, the vegetable oil and the glycerol. As an embodiment of the present disclosure, the kneading is performed at a temperature of 15-35° C., specifically 15° C., 20° C., 25° C., 30° C. or 35° C., for a duration of 6-10 h, specifically 6 h, 7 h, 8 h, 9 h or 10 h, with a rotational speed of 15-45 rpm, specifically 15 rpm, 20 rpm, 25 rpm, 30 rpm, 35 rpm, 40 rpm or 45 rpm. In the embodiment of the present disclosure, the kneading is specifically performed in a kneader. In the embodiment of the present disclosure, the mixing and the kneading performed under the above conditions is beneficial for obtaining the kneaded material with a uniform texture and stable performance.

After the kneaded material is obtained, the kneaded material is subjected to the extrusion molding, the drying and the degumming in sequence to obtain the degummed green body. In the present disclosure, according to the specific shape of the R-SiC gas filtration membrane, the extrusion molding is performed to obtain the green body. For example, under a condition that the R-SiC gas filtration membrane is a single-channel tubular membrane, the single-channel tubular membrane green body is obtained through the extrusion molding. In the present disclosure, there is no specific limitation on operating conditions for the extrusion molding, and a condition well known to those skilled in the art may be used. In the embodiment of the present disclosure, the extrusion molding is specifically performed in an extruder. The present disclosure employs wet extrusion molding, which has at least the following advantages: 1. Continuous and efficient production: the wet extrusion molding can realize continuous production, greatly improving production efficiency. 2. Wide applicability: by changing a grinding tool, different types of filtration membranes and customized membranes can be extruded. 3. Simple equipment and small investment: compared with the injection molding machine and the calender, the wet extrusion molding equipment has a simple structure, small investment, convenience in installation and commissioning, small footprint, and low requirements on the workshops and supporting facilities.

In the present disclosure, after the green body is obtained, the drying is performed on the green body to obtain a dried green body. In the present disclosure, there is no specific limitation on the drying, as long as moisture in the green body can be removed. In the embodiment of the present disclosure, the drying is specifically performed in an oven.

In the present disclosure, after the dried green body is obtained, the degumming is performed on the dried green body to obtain a degummed green body. As an embodiment of the present disclosure, the degumming is performed at a temperature of 115-125° C., specifically 115° C., 118° C., 120° C., 122° C. or 125° C., for a duration of 2-4 h, specifically 2 h, 2.5 h, 3 h, 3.5 h or 4 h. In the embodiment of the present disclosure, the degumming performed under the above conditions can effectively remove the vegetable oil and the glycerol to obtain the gas filtration membrane with excellent performance.

In the present disclosure, after the degummed green body is obtained, the sintering-coating treatment is performed on the degummed green body to obtain the R-SiC gas filtration membrane. As an embodiment of the present disclosure, the sintering-coating treatment includes sequentially performing sintering and coating; and the sintering-coating treatment is performed 3-4 times.

As an embodiment of the present disclosure, the sintering each time is independently performed at a temperature of 2,400-2,500° C., specifically 2,410° C., 2,420° C., 2,430° C., 2,440° C., 2,450° C., 2,460° C., 2,470° C., 2,480° C., 2,490° C. or 2,500° C., for a duration of 3-5 h, specifically 3 h, 3.5 h, 4 h, 4.5 h or 5 h. As an embodiment of the present disclosure, taking the temperature of 2,450° C. for the sintering as an example, a heating program for heating to the temperature required by the sintering is uniformly heating to 200° C. from room temperature within 30 min, uniformly heating to 900° C. from 200° C. within 60 min, uniformly heating to 1,100° C. from 900° C. within 30 min, uniformly heating to 2,000° C. from 1,100° C. within 45 min, uniformly heating to 2,410° C. from 2,000° C. within 20 min, and uniformly heating to 2,450° C. from 2,410° C. within 10 min. As an embodiment of the present disclosure, the method further includes performing cooling after the sintering each time. In some embodiments, the cooling is specifically natural cooling, and the temperature after the cooling each time is specifically room temperature.

As an embodiment of the present disclosure, a coating agent used for the coating each time includes SiC, cellulose, dextran, vegetable oil, glycerol and water. In some embodiments, a mass ratio of the SiC to the cellulose to the dextran to the vegetable oil to the glycerol to the water in the coating agent is 70:(8-10):(3-5):(5-7):(1-3):(8-10), specifically 70:9:6:2:9. In some embodiments, the coating each time is independently performed at a pressure of 0.0005-0.0015 MPa, specifically 0.001 MPa.

In the present disclosure, the SiC can be recrystallized through the sintering. A pore structure may be formed during the recrystallization, and a pore size can be reduced through the coating. In the embodiment of the present disclosure, the sintering-coating treatment performed under the above conditions enables the R-SiC gas filtration membrane to achieve an appropriate pore size and an appropriate porosity, ensuring a desirable purification effect on the gas, and improving the purification efficiency.

In some embodiments, after the sintering-coating treatment, the method further includes performing detection. The R-SiC gas filtration membrane becomes a finished product once passing through the detection. As an embodiment of the present disclosure, the specific detection requirements are as follows:
1 General requirements and hygienic safety requirements
1.1 The component shall be made of a nontoxic, harmless and nonradioactive material.
1.3 The component shall meet the Standard for Hygienic Safety Evaluation of Equipment and Protective Materials in Drinking Water.
2 Appearance quality

The whole component shall be uniform in color and free from cracks, pits, notches and peeling phenomena observed by the naked eyes; and its section shall be flat.
3 Requirements on outer dimensions
3.1 Allowable deviations on the diameter of the component and the inner diameter of the flow channel shall meet the regulations in Table 1.
3.2 The curvature of the component shall meet the regulations in Table 2.
3.3 The allowable tolerance on the diameter of the actual channel of the component shall not be greater than 5% of the nominal channel diameter.
3.4 The component shall have a minimum length of 200 mm, and a maximum length of 1,500 mm.

TABLE 1
Allowable tolerance on the diameter

| | Indicator | |
|---|---|---|
| | Diameter of the | Diameter of the |
| | component: | component: |
| Item | 41 mm | 30 mm or 25 mm |
| Allowable deviation on the diameter | ≤0.6 | ≤0.5 |
| (mm) | | |
| Allowable deviation on the inner | ≤0.2 | |
| diameter of the flow channel (mm) | | |

TABLE 2
Curvature

| | Indicator | |
|---|---|---|
| | Length of the | Length of the |
| Item | component: 1,000 mm | component: 1,200 mm |
| Curvature (mm) | ≤3 | ≤3 |

4 Performance requirements
4.1 The pure water flux, overall bubble-point pressure and membrane porosity of the component shall meet the regulations in Table 3.

TABLE 3
Performance requirements

Indicator (pore size)

| Item | 0.05 μm | 0.1 μm |
|---|---|---|
| Pure water flux (m³ m⁻² h⁻¹) | ≥1 | ≥2 |
| Overall bubble-point pressure (MPa) | ≥0.2 | ≥0.15 |

| | |
|---|---|
| Membrane porosity (%) | ≥40 |

4.2 The flexural strength of the component shall meet the regulations in Table 4.

TABLE 4
Flexural strength

| | Indicator | | |
|---|---|---|---|
| | Outer diameter | Outer diameter | Outer diameter |
| | of the | of the | of the |
| | component: | component: | component: |
| Item | 30 mm | 41 mm | 60 mm |
| Flexural strength | ≥2,000 | ≥3,500 | ≥4,000 |
| (N) | | | |

4.3 The corrosion resistance of the component to acids and alkalis shall meet the regulations in Table 5.

TABLE 5
Corrosion resistance to acids and alkalis

| | | Indicator | | |
|---|---|---|---|---|
| | | Outer diameter | Outer diameter | Outer diameter |
| | | of the | of the | of the |
| | | component: | component: | component: |
| Item | | 30 mm | 41 mm | 60 mm |
| Corrosion | Flexural | ≥1,500 | ≥2,500 | ≥3,500 |
| resistance | strength | | | |
| to acids | (N) | | | |
| Corrosion | Flexural | ≥1,500 | ≥2,500 | ≥3,500 |
| resistance | strength | | | |
| to alkalis | (N) | | | |

4.4 The defect rate of the component shall meet the regulations in Table 6 (for all types of products).

TABLE 6
Defect rate

| Indicator | Remarks |
|---|---|
| Defect rate ≤1% | In case of a crack, the component with the defect rate |
| | of less than 1% shall also be scrapped. |

4.5 The pore size of the component shall meet the regulations in Table 7.

TABLE 7
Pore size

| Pore size of | | | |
|---|---|---|---|
| products | | Indicator | Remarks |
| 0.1 | μm | 95% of pore sizes | Other 5% of pore sizes are not |
| | | are 0.1 μm ± 30% | greater than 0.5 μm |
| 0.05 | μm | 95% of pore sizes | Other 5% of pore sizes are not |

| | |
|---|---|
| are 0.05 μm ± 30% | greater than 0.02 μm |

The R-SiC gas filtration membrane prepared according to the method in the present disclosure has desirable thermostability, and can be used at a temperature of higher than 400° C. or even up to 800° C. It exhibits desirable chemical stability, resistance to acids, alkalis and organic solvents, is suitable for a wide pH range, can be used in strongly corrosive media, and can be cleaned with chemical agents. The R-SiC gas filtration membrane has a high mechanical strength, and can be used at a relatively high pressure. It exhibits strong antimicrobial ability, and is not reactive with microbes, nontoxic and pollution-free to a separated system, and thus has unique advantages in the food field and biochemical field.

After the R-SiC gas filtration membrane is obtained, the R-SiC gas filtration membrane is used to purify the to-be-treated gas to obtain the purified gas.

As an embodiment of the present disclosure, the to-be-treated gas has a pH value of 0-14, further 4-12, and specifically 4, 5, 6, 7, 8, 9, 10, 11 or 12. Thus, the R-SiC gas filtration membrane of the present disclosure could purify a neutral gas, an acidic gas, and also an alkaline gas. As an embodiment of the present disclosure, a temperature of the to-be-treated gas ranges from room temperature to 800° C., and is further in a range of 30-650° C., still further in a range of 50-350° C., and specifically 50° C., 60° C., 80° C., 100° C., 150° C., 200° C., 250° C., 300° C. or 350° C.

Thus, the R-SiC gas filtration membrane of the present disclosure could purify a room-temperature gas, and also a high-temperature gas. As an embodiment of the present disclosure, an impurity content in the to-be-treated gas is ≤5% by volume, is further in a range of 1-5%, and specifically 1%, 2%, 3%, 4% or 5%. As an embodiment of the present disclosure, the to-be-treated gas is a pure gas, and is also a mixed gas, which is processed according to an actual need.

As an embodiment of the present disclosure, the to-be-treated gas includes nitrogen and ammonia. In some embodiments, the to-be-treated gas have the pH value of 11.5-12.5 (specifically 12), the temperature of 50-60′C, and the impurity content of 1-2.5% by volume, specifically 1%, 1.2%, 1.5%, 1.8%, 2%, 2.2% or 2.5%.

As an embodiment of the present disclosure, the to-be-treated gas has the pH value of 3.5-4.5 (specifically 4), the temperature of 300-350° C., and the impurity content of 1-5% by volume, specifically 1%, 1.2%, 1.5%, 2%, 2.5%, 3%, 3.5%, 4%, 4.5% or 5%.

As an embodiment of the present disclosure, the purification is performed under conditions that a flow velocity of the to-be-treated gas being ≤30 m/s, further being 15-30 m/s, and specifically being 15 m/s, 20 m/s, 25 m/s or 30 m/s; a pressure being ≤1 kPa, further being 0.45-1 kPa, and specifically being 0.45 kPa, 0.6 kPa, 0.8 kPa or 1 kPa; an environmental temperature being ≤50° C., further being 25-40° C., and specifically being 25° C., 30° C., 35° C. or 40° C.; and a relative humidity being ≤45%, further being 30-45%, and specifically being 30%, 35%, 40% or 45%.

As an embodiment of the present disclosure, the purified gas has the impurity content of 0.5% by volume, further 0.1-0.5%, and specifically 0.1%, 0.2%, 0.3%, 0.4% or 0.5%.

The R-SiC gas filtration membrane prepared according to the method in the present disclosure has the appropriate pore size and porosity. While requirements on purification accuracy, pressure and flux can be met, the working temperature of the R-SiC gas filtration membrane can be increased to 800° C., filling the blank that other filtration media are not resistant to high temperatures. The R-SiC gas filtration membrane can be used to purify the acidic gas or the alkaline gas, without secondary pollution caused by other media. Due to characteristics of high hardness and corrosion resistance of the R-SiC, the service life of the R-SiC gas filtration membrane is greatly improved, the maintenance period is prolonged, and the operation cost is reduced.

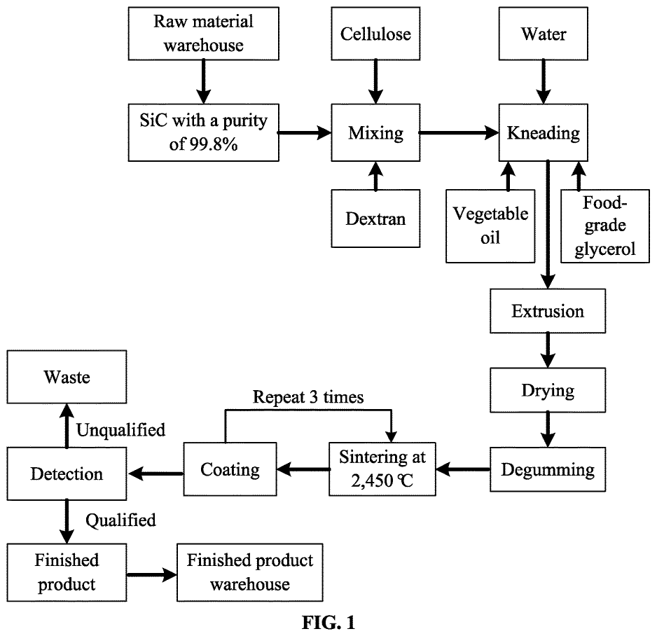

FIG. 1 illustrates a flowchart of the R-SiC gas filtration membrane according to an embodiment of the present disclosure. The technical solutions in the present disclosure will be clearly and completely described below with reference to the examples of the present disclosure. Apparently, the described examples are merely a part rather than all of the examples of the present disclosure. All other examples obtained by a person of ordinary skill in the art based on the examples of the present disclosure without creative efforts shall fall within the scope of the present disclosure.

In the experiments below, the SiC has a purity of 99.8 wt %, and a particle size of 0.7-1.2 μm. The SiC with a particle size ≥1 μm accounts for 50% or more of a total weight of the SiC. The SiC powder is provided by the Shenyang Changxin New Materials Co., Ltd, China. The glycerol is food-grade glycerol with a purity of 98%. The dextran is dextran xt300. The water is purified water.

### Example 1

SiC, cellulose and dextran were mixed to obtain a mixture. The mixture, water, vegetable oil and glycerol were put into a kneader, and kneaded for 6 h at room temperature and a stirring speed of 30 rpm to obtain a kneaded material. A mass ratio of the SiC to the cellulose to the dextran to the vegetable oil to the glycerol to the water was 70:9:4:6:2:9.

The kneaded material was put into an extruder and extruded to obtain a single-channel tubular membrane green body.

The single-channel tubular membrane green body was put into an oven and dried to remove moisture, thereby obtaining a dried single-channel tubular membrane green body.

The dried single-channel tubular membrane green body was put into a degumming furnace, and degummed for 3 h at 120° C. to remove the vegetable oil and the glycerol, thereby obtaining a degummed single-channel tubular membrane green body.

The degummed single-channel tubular membrane green body was put into a vacuum induction sintering furnace, uniformly heated to 200° C. from room temperature within 30 min, uniformly heated to 900° C. from 200° C. within 60 min, uniformly heated to 1,100° C. from 900° C. within 30 min, uniformly heated to 2,000° C. from 1,100° C. within 45 min, uniformly heated to 2,410° C. from 2,000° C. within 20 min, uniformly heated to 2,450° C. from 2,410° C. within 10 min, sintered for 4 h at 2,450° C., and then naturally cooled to the room temperature, thereby obtaining a sintered single-channel tubular membrane green body. At a pressure of 0.001 MPa, an inner wall of the sintered single-channel tubular membrane green body was coated by a coater to obtain a coated single-channel tubular membrane green body. A coating agent for coating is a mixture of SiC, cellulose, dextran, vegetable oil, glycerol and water in a mass ratio of 70:9:4:6:2:9. Then, sintering-coating treatment was repeated sequentially for 3 times to obtain an R-SiC gas filtration membrane (which was specifically a single-channel tubular membrane).

Then, detection was performed with a bubble press and a flux meter (the detection was performed with reference to the foregoing detection requirements 1-4, and was not repeated herein). A qualified product was stored in a finished products warehouse. The R-SiC gas filtration membrane has a length of 80 mm, an inner diameter of 21 mm, and an outer diameter of 35 mm.

### Example 2

The R-SiC gas filtration membrane was prepared with reference to the method in Example 1, except that the size of the R-SiC gas filtration membrane was different. The R-SiC gas filtration membrane in this example has a length of 1,200 mm, an inner diameter of 21 mm, and an outer diameter of 35 mm.

### Use Example 1

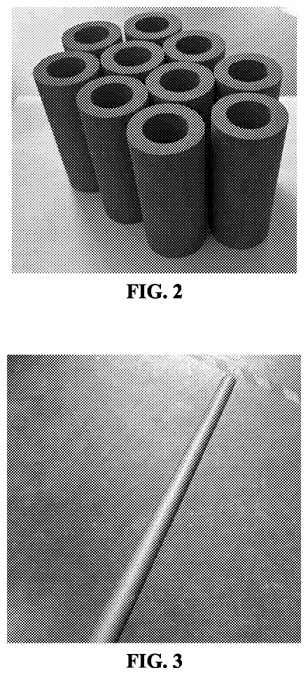

The R-SiC gas filtration membrane was prepared according to the method in Example 1. With the physical image shown in FIG. 2, the R-SiC gas filtration membrane has a length of 80 mm, an inner diameter of 21 mm, and an outer diameter of 35 mm. The R-SiC gas filtration membrane was used to purify a to-be-treated alkaline mixed gas from the Wuhan Zhisheng Environmental Protection Science and Technology Co., Ltd., China to obtain a purified alkaline mixed gas. The to-be-treated alkaline mixed gas has a pH value of 12 and a temperature of 50-60° C., consists mainly of nitrogen and ammonia, and further contains an impurity such as dust, in which an impurity content was 2.5% by volume. The purification was performed under conditions of: a flow velocity of the to-be-treated alkaline mixed gas of 15 m/s, a pressure of 0.45 kPa, an environmental temperature of 25° C., and a relative humidity of 35%. The impurity content in the purified alkaline mixed gas was 0.5% by volume. The above indicates that the R-SiC gas filtration membrane prepared in the present disclosure can realize purification on the to-be-treated alkaline mixed gas.

### Use Example 2

The R-SiC gas filtration membrane was prepared according to the method in Example 2. With the physical image shown in FIG. 3, the R-SiC gas filtration membrane has a length of 1,200 mm, an inner diameter of 21 mm, and an outer diameter of 35 mm. The R-SiC gas filtration membrane was used to purify a to-be-treated acidic gas from the Sichuan Sidaneng Environmental Protection Technology Co. Ltd., China to obtain a purified acidic gas. The to-be-treated acidic gas has a pH value of 4 and a temperature of 300-350° C., consists mainly of hydrogen chloride, and further contains an impurity such as dust, in which an impurity content was 1% by volume. The purification was performed under conditions of: a flow velocity of the to-be-treated acidic gas of 25 m/s, a pressure of 1 kPa, an environmental temperature of 40° C., and a relative humidity of 40%. The impurity content in the purified acidic gas was 0.3% by mass. The above indicates that the R-SiC gas filtration membrane prepared in the present disclosure can realize purification on the to-be-treated acidic gas.

As can be seen from the above results, in the present disclosure, the to-be-treated gas is purified using the R-SiC gas filtration membrane. The R-SiC gas filtration membrane exhibits stronger corrosion resistance to acids and alkalis, and can be widely used to purify the special gases such as the acidic gas or the alkaline gas. Further, the R-SiC gas filtration membrane has high-temperature resistance, and can directly purify a high-temperature gas in the special industry without pre-cooling the high-temperature gas. Moreover, the SiC exhibits a Mohs hardness up to 9.2-9.5, and is considered as one of the hardest materials in nature after diamond. The R-SiC gas filtration membrane with the superb hardness has a long service life while ensuring a desirable purification effect, reducing the operation cost.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

1.-10. (canceled)

11. A gas purification method, comprising:
subjecting a to-be-treated gas to purification using a recrystallized silicon carbide (R-SiC) gas filtration membrane to obtain a purified gas,
wherein the R-SiC gas filtration membrane is prepared by a process comprising:
mixing SiC, cellulose, dextran, vegetable oil, glycerol and water, and performing kneading to obtain a kneaded material;
subjecting the kneaded material to extrusion molding, drying and degumming in sequence to obtain a degummed green body; and
subjecting the degummed green body to sintering-coating treatment to obtain the R-SiC gas filtration membrane.

12. The gas purification method according to claim 11, wherein the R-SiC gas filtration membrane is selected from a group consisting of a single-channel tubular membrane and a multi-channel tubular membrane;
the single-channel tubular membrane has an inner diameter of 15-25 mm, an outer diameter of 30-40 mm, and a length of 1,000-1,500 mm; and
each channel in the multi-channel tubular membrane has an inner diameter of 2-25 mm, and the multi-channel tubular membrane has a length of 1,000-1,500 mm.

13. The gas purification method according to claim 11, wherein the to-be-treated gas has a pH value of 0-14, a temperature ranging from room temperature to 800° C., and an impurity content less than or equal to 5% by volume.

14. The gas purification method according to claim 13, wherein the to-be-treated gas comprises nitrogen and ammonia; and the to-be-treated gas has the pH value of 11.5-12.5, the temperature of 50-60° C., and the impurity content of 1-2.5% by volume.

15. The gas purification method according to claim 13, wherein the to-be-treated gas comprises hydrogen chloride; and the to-be-treated gas has the pH value of 3.5-4.5, the temperature of 300-350° C., and the impurity content of 1-5% by volume.

16. The gas purification method according to claim 11, wherein the purification is performed under conditions: a flow velocity of the to-be-treated gas less than or equal to 30 m/s, a pressure less than or equal to 1 kPa, an environmental temperature less than or equal to 50° C., and a relative humidity less than or equal to 45%.

17. The gas purification method according to claim 12, wherein the purification is performed under conditions: a flow velocity of the to-be-treated gas less than or equal to 30 m/s, a pressure less than or equal to 1 kPa, an environmental temperature less than or equal to 50° C., and a relative humidity less than or equal to 45%.

18. The gas purification method according to claim 13, wherein the purification is performed under conditions: a flow velocity of the to-be-treated gas less than or equal to 30 m/s, a pressure less than or equal to 1 kPa, an environmental temperature less than or equal to 50° C., and a relative humidity less than or equal to 45%.

19. The gas purification method according to claim 14, wherein the purification is performed under conditions: a flow velocity of the to-be-treated gas less than or equal to 30 m/s, a pressure less than or equal to 1 kPa, an environmental temperature less than or equal to 50° C., and a relative humidity less than or equal to 45%.

20. The gas purification method according to claim 15, wherein the purification is performed under conditions: a flow velocity of the to-be-treated gas less than or equal to 30 m/s, a pressure less than or equal to 1 kPa, an environmental temperature less than or equal to 50° C., and a relative humidity less than or equal to 45%.

21. The gas purification method according to claim 11, wherein a mass ratio of the SiC to the cellulose to the dextran to the vegetable oil to the glycerol to the water is 70:8-10:3-5:5-7:1-3:8-10.

22. The gas purification method according to claim 11, wherein the kneading is performed at a temperature of 15-35° C. for a duration of 6-10 hours, with a rotational speed of 15-45 rpm; and
the degumming is performed at a temperature of 115-125° C. for a duration of 2-4 hours.

23. The gas purification method according to claim 21, wherein the kneading is performed at a temperature of 15-35° C. for a duration of 6-10 hours, with a rotational speed of 15-45 rpm; and
the degumming is performed at a temperature of 115-125° C. for a duration of 2-4 hours.

24. The gas purification method according to claim 11, wherein the sintering-coating treatment comprises sequentially performing sintering and coating; and the sintering-coating treatment is performed 3-4 times.

25. The gas purification method according to claim 24, wherein the sintering each time is independently performed at a temperature of 2,400-2,500° C. for a duration of 3-5 h; and
a coating agent used for the coating each time comprises SiC, cellulose, dextran, vegetable oil, glycerol and water; a mass ratio of the SiC to the cellulose to the dextran to the vegetable oil to the glycerol to the water in the coating agent is 70:8-10:3-5:5-7:1-3:8-10; and the coating each time is independently performed at a pressure of 0.0005-0.0015 MPa.
